(19) United States
(12) Patent Application Publication
(10) Pub. No.: US 2018/0196268 A1
(43) Pub. Date: Jul. 12, 2018

(54) Adjustable Video Headset

(71) Applicant: Avegant Corp., Belmont, CA (US)

(72) Inventors: Christopher David Westra, San Carlos, CA (US); Geoffrey Michael Hill, San Francisco, CA (US); Michael Alexander Young, Belmont, CA (US)

(21) Appl. No.: 15/862,574

(22) Filed: Jan. 4, 2018

Related U.S. Application Data
(60) Provisional application No. 62/442,422, filed on Jan. 4, 2017.

(51) Int. Cl. G02B 27/01; G02B 7/00

(52) U.S. Cl. CPC G02B 27/0176; G02B 2027/0132; G02B 2027/0154; G02B 7/004

(57) ABSTRACT

An adjustable headset comprising an optics module including a left eye piece and a right eye piece, and a right eye piece control including an adjustment wheel and integrated slider, the adjustment wheel changing a diopter setting, and the slider moving an optical assembly side to side to change an inter pupillary distance setting, such that a single point of interaction enables optical adjustments for the right eye.

### RELATED APPLICATION

The present application claims priority to U.S. Provisional Application No. 62/442,422 filed on Jan. 4, 2017, and incorporated herein by reference.

### FIELD

The present invention relates to headsets, and more particularly to virtual reality headsets.

### BACKGROUND

Headset based displays are becoming more common. However, many of headsets are heavy or uncomfortable.

### BRIEF DESCRIPTION OF THE FIGURES

The present invention is illustrated by way of example, and not by way of limitation, in the figures of the accompanying drawings and in which like reference numerals refer to similar elements and in which:

FIG. 1 is a perspective view of one embodiment of an improved adjustable headset.

FIG. 2 is a view of one embodiment of the headset in a social mode.

FIG. 3 is a side view of one embodiment of the headset showing eye relief adjustment.

FIG. 4 shows one embodiment of the optics module.

FIG. 5 illustrates one embodiment of the optical assembly from the bottom.

FIG. 6 is a diagram of one embodiment of the diopter adjustment mechanism.

FIG. 7 is a diagram of one embodiment of the IPD adjustment mechanism.

FIG. 8 is a diagram of one embodiment of the gearing for a combined diopter and IPD adjustment system.

### DETAILED DESCRIPTION

An improved adjustable headset is described. The headset is designed for use with video, augmented reality, virtual reality, or other types of near eye displays. In one embodiment, the headset is adjustable in multiple ways, including Head Circumference, Eye Relief, IPD, Diopter and Vertical Position.

The following detailed description of embodiments of the invention makes reference to the accompanying drawings in which like references indicate similar elements, showing by way of illustration specific embodiments of practicing the invention. Description of these embodiments is in sufficient detail to enable those skilled in the art to practice the invention. One skilled in the art understands that other embodiments may be utilized and that logical, mechanical, electrical, functional and other changes may be made without departing from the scope of the present invention. The following detailed description is, therefore, not to be taken in a limiting sense, and the scope of the present invention is defined only by the appended claims.

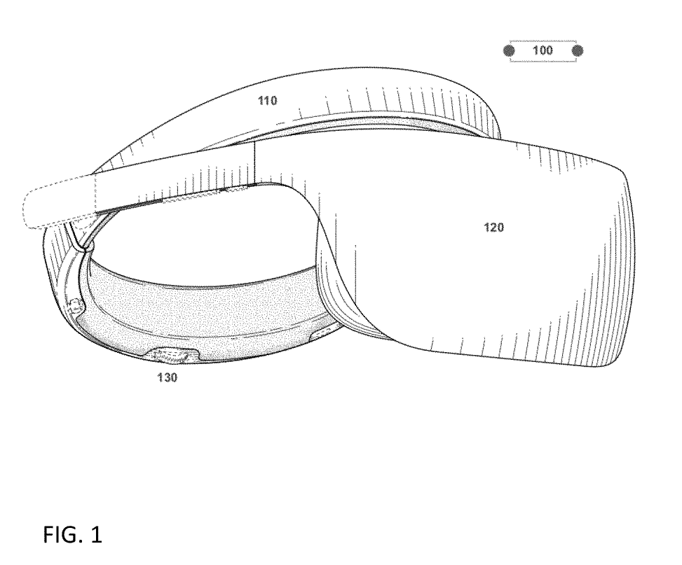

FIG. 1 is perspective view of one embodiment of a headset. In one embodiment, the headset 100 includes a halo 110 or strap encircling the user's head, and an optics module 120, or glasses, extending forward. In one embodiment, the glasses 120 can be positioned in front of the user's eyes as shown in FIG. 1, or can be lifted up, to be in “social mode.”

In one embodiment, head size adjustment enables the strap to fit the user's head properly. In one embodiment, the strap may be adjusted using an adjustment wheel 130. In one embodiment, the halo can be expanded or contracted by up to 150 mm of circumference, enabling the same headset to be worn by people of various head sizes.

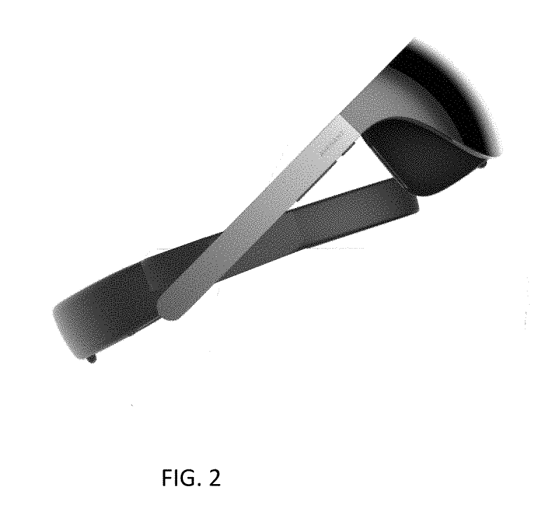

The adjustment wheel 130 may be positioned on the back of the halo 110 (and thus the back of the user's head). Once the halo 110 is positioned on the head, the adjustment wheel 130 enables tightening or loosening of the halo 110 to arrive at a comfortable fit on the user's head, In one embodiment, by using a form-fitted halo 110, the movement of the glasses 120 can be accomplished without disrupting other settings. This enables the user to tip up the glasses, in a social mode, as shown in FIG. 2. In one embodiment, a friction hinge is used for this adjustment. In another embodiment, a hinge having two set-points, an “in-use” and a “social” position is used, so that the glasses are stable in two positions. In one embodiment, the glasses are positioned horizontally, and then rotate about a hinge to the social mode.

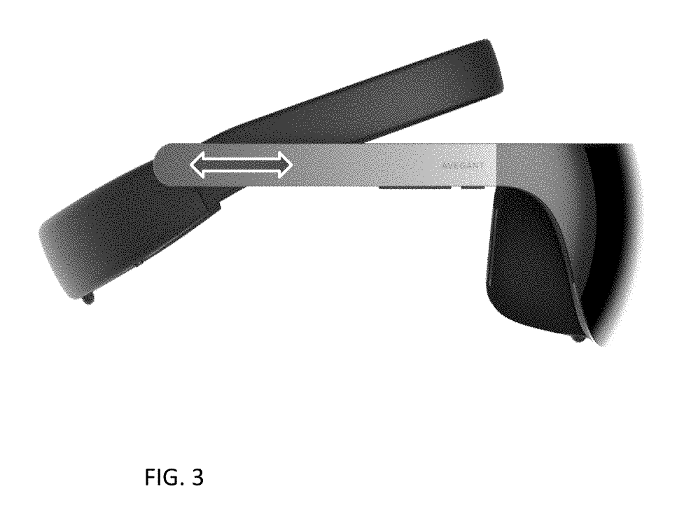

FIG. 3 is a side view of one embodiment of the headset showing eye relief adjustment. In one embodiment, the eye relief adjustment is achieved by sliding the glasses forward and back with respect to a point on the halo. In one embodiment, the range of motion is 25 mm. In one embodiment, the sliding is accomplished using fixed friction linear bearings. This allows the user to wear the headset with or without glasses and to adjust for optimal image quality. In one embodiment, the forward positioning of the glasses remains unadjusted when the user tips up the glasses to a social mode. In this way, the user may tip up the glasses to interact with others, and then tip down the glasses and get re-immersed in the VR/AR display without requiring re-adjustment of any other settings.

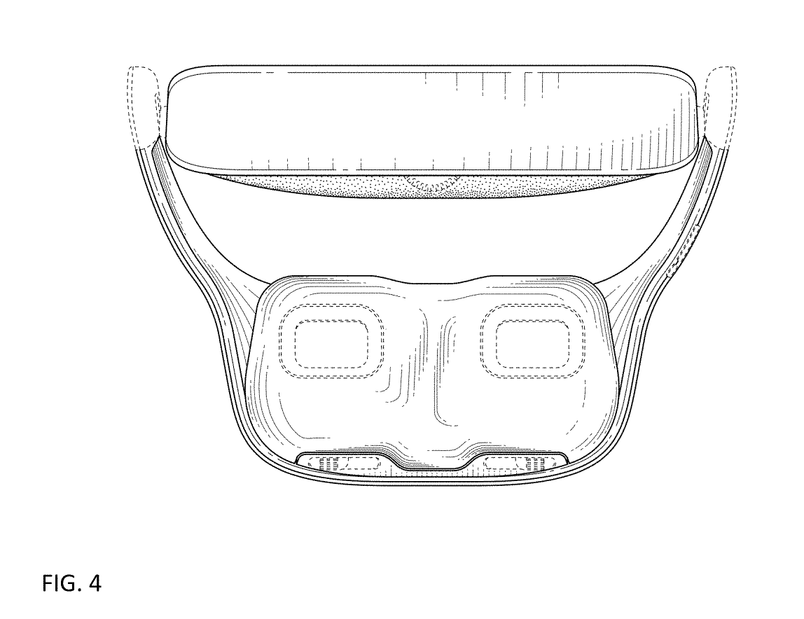

FIG. 4 shows one embodiment of the optics module, which includes a display element, optics, and an eye box which encloses those elements (“optics module”). The eye box, in one embodiment, is a plastic and flexible fabric element which rests on the user's nose, positioning the optics module. In one embodiment, the flexible fabric is Lycra. In one embodiment, the nose portion is shaped, and the Lycra surrounds the eye box.

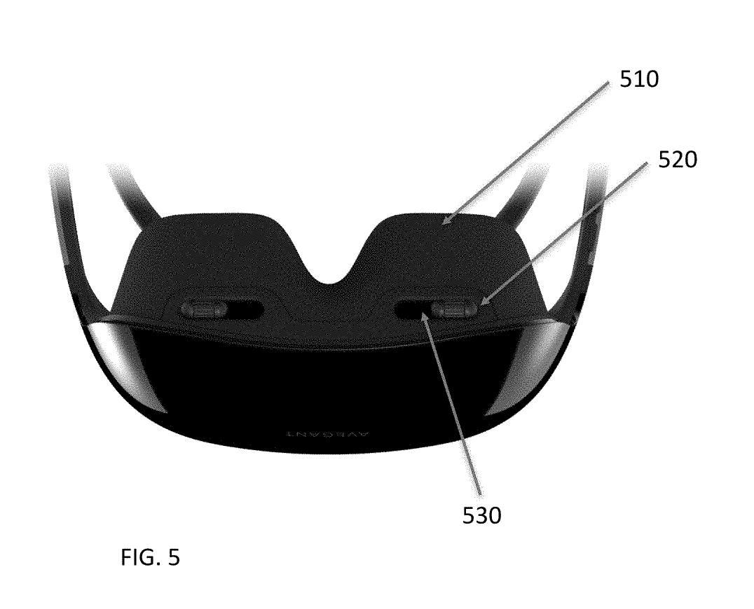

FIG. 5 illustrates one embodiment of the optical assembly from the bottom. In one embodiment, the optical elements in the glasses may be adjusted for diopters and for inter-pupillary distance (IPD). In one embodiment, diopter adjustment is achieved by rotating a diopter dial 520 below the corresponding Left or Right Optical Subassembly 510. The diopter dial provides magnification and enables the use of the system without glasses.

In one embodiment, IPD adjustment is achieved by sliding the IPD slider 530 below the corresponding Left or Right Optical Subassembly 510.

In one embodiment, the diopter and IPD adjustment may be implemented in a dual adjustment mechanism with the primary axes of actuation being perpendicular to each other to avoid user confusion.

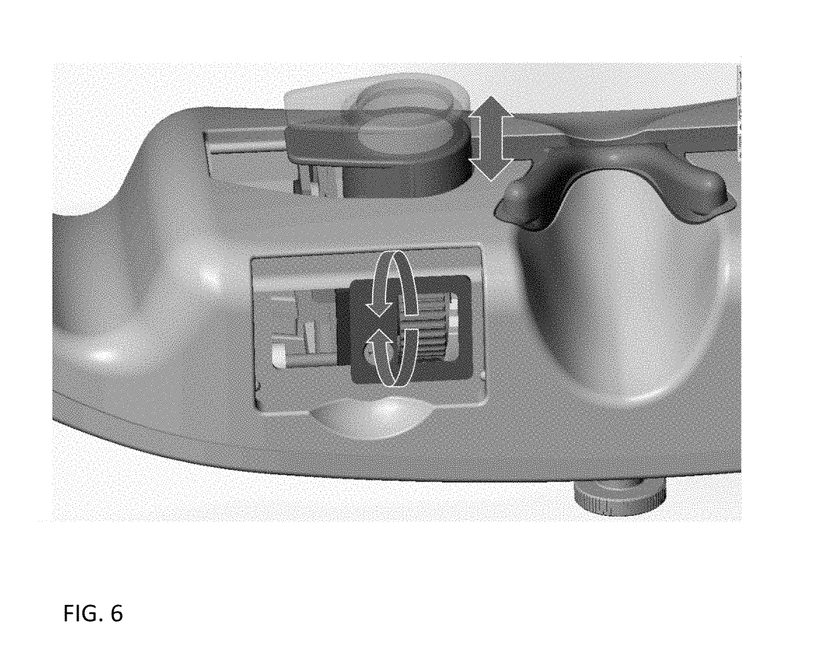

FIG. 6 is a diagram of one embodiment of the diopter adjustment mechanism. In one embodiment, the diopter wheel rotates within the optics module. In one embodiment, the rotation is perpendicular to the optical element. The diopter adjustment moves the eye piece closer to or further from the user. In one embodiment, gearing within the eye piece enables this movement.

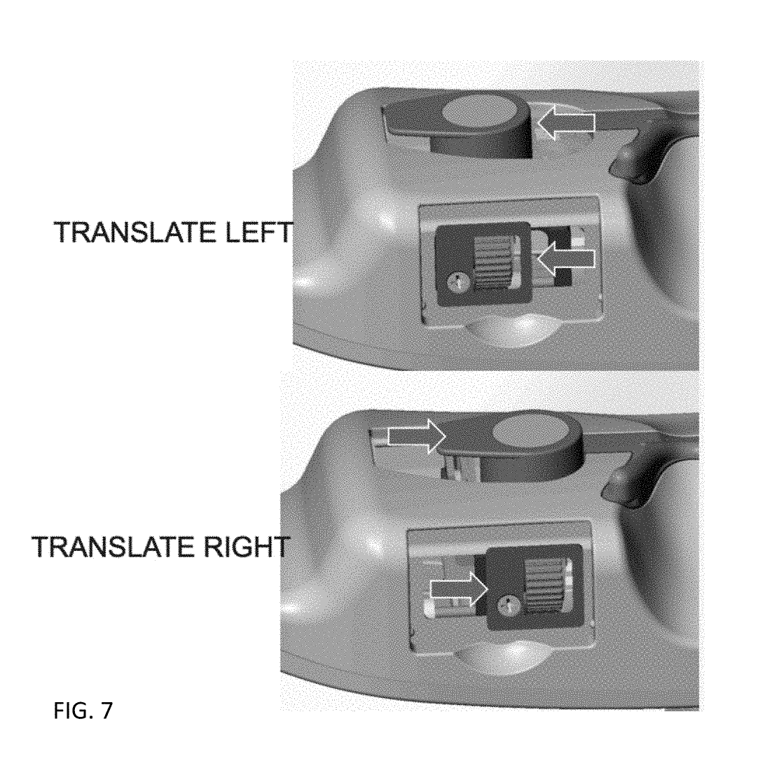

FIG. 7 is a diagram of one embodiment of the IPD adjustment mechanism. The IPD adjustment 710 is a slider which slides parallel to the optical element. In one embodiment, the slider moves the eye pieces closer or further apart. In one embodiment, each eye piece has its own adjustor. In one embodiment, as shown in FIG. 7, the movement of the IPD adjustment slider also moves the diopter wheel position. However, the movement of the IPD adjustment slider does not alter the settings of the diopter wheel, only its position with respect to the optical element.

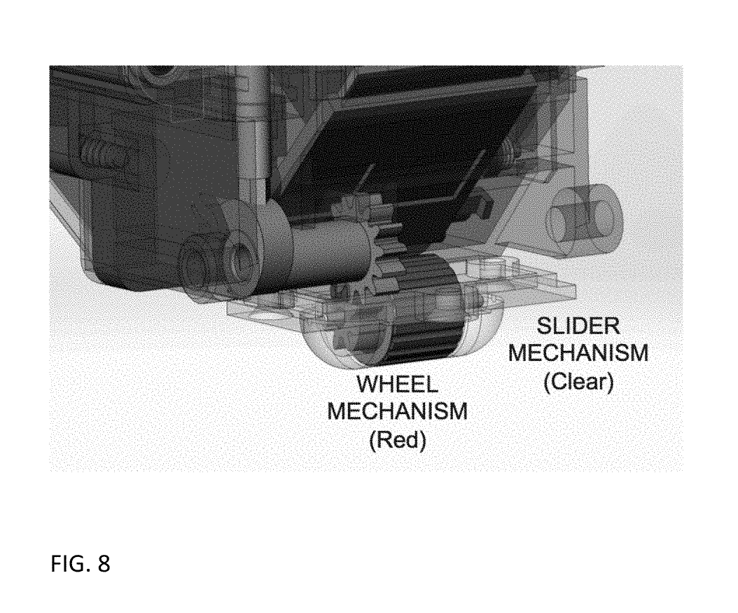

FIG. 8 is a diagram of one embodiment of the gearing for a combined diopter and IPD adjustment system. A wheel mechanism and slider mechanism are combined in to a single control that provides benefit to the user by concentrating two related adjustments into a single point of interaction. The adjustment wheel (shown in red) rotates a gear (green) connected to a cam wheel. The cam wheel moves a pin (gray) to change the diopter or focus setting. The slider (dear) moves the optical assembly side to side to change the inter pupillary distance setting.

This combination of adjustment mechanisms provides an improved headset with a simple but complete set of adjustment mechanisms.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. An adjustable headset comprising:
an optics module including a left eye piece and a right eye piece;
a right eye piece control including an adjustment wheel and integrated slider, the adjustment wheel changing a diopter setting, and the slider moving an optical assembly side to side to change an inter pupillary distance setting; and
a left eye piece control including an adjustment wheel and integrated slider, the adjustment wheel changing a diopter setting, and the slider moving an optical assembly side to side to change an inter pupillary distance setting;
such that a single point of interaction enables optical adjustments.

2. The adjustable headset of claim 1, further comprising:
a halo to support the optics module, the halo designed to be fixed around a user's head.

3. The adjustable headset of claim 2, wherein the halo is adjustable using an adjustment wheel.

4. The adjustable headset of claim 2, wherein the optics module is moveable with respect to the halo such that the adjustable headset has an in-use mode and a social mode, where the optics module is positioned above the eyes of the user in the social mode, enabling the user to interact with others without removing the adjustable headset.

5. The adjustable headset of claim 2, further comprising:
a sliding mechanism to slide the optics module forward and backward with respect to the halo, to adjust a forward position of the optics module for eye relief adjustment while maintaining other settings.

6. The adjustable headset of claim 5, wherein the sliding mechanism uses fixed friction linear bearings and remains in an adjusted position once adjusted.

7. The adjustable headset of claim 6, further comprising:
a rotating hinge to enable movement of the optics module upward with respect to a user's eyes, such that the adjustable headset has an in-use mode and a social mode, where the optics module is positioned above the eyes of the user in the social mode enabling the user to interact with others without removing the adjustable headset.

8. The adjustable headset of claim 7, wherein the sliding mechanism maintains the forward position of the optics module in the social mode.

9. The adjustable headset of claim 1, wherein the adjustment wheel rotates a gear connected to a cam wheel, the cam wheel moves a pin to change the diopter.

10. An adjustable headset including two eye pieces, the headset comprising:
an integrated control for each eye piece comprising an adjustment wheel and a slider, the adjustment wheel for changing a diopter setting, and the slider for changing an inter pupillary distance setting to position the eye piece correctly for a user's eyes; and
such that a single point of interaction enables optical adjustments.

11. The adjustable headset of claim 10, further comprising:
a halo designed to be fixed around a user's head to support the adjustable headset.

12. The adjustable headset of claim 11, wherein the halo is adjustable using an adjustment wheel positioned on a back of the headset.

13. The adjustable headset of claim 11, further comprising:
a hinge to enable moving the eye pieces such that the adjustable headset has an in-use mode and a social mode, wherein the eye pieces are positioned above the user's eyes of the user in the social mode, enabling the user to interact with others without removing the adjustable headset.

14. The adjustable headset of claim 11, further comprising:
a sliding mechanism to slide the eye pieces forward and backward with respect to the halo, to adjust a forward position of the eye pieces for eye relief adjustment while maintaining other settings.

15. The adjustable headset of claim 14, wherein the sliding mechanism uses fixed friction linear bearings and remains in an adjusted position once adjusted.

16. The adjustable headset of claim 15, further comprising:
a rotating hinge to enable movement of the eye pieces upward with respect to the user's eyes, such that the adjustable headset has an in-use mode and a social mode, where the optics module is positioned above the eyes of the user in the social mode enabling the user to interact with others without removing the adjustable headset.

17. The adjustable headset of claim 10, wherein the adjustment wheel rotates a gear connected to a cam wheel, the cam wheel moves a pin to change the diopter.

18. An adjustable headset comprising:
an optics module including a left eye piece and a right eye piece;
a right eye piece comprising a right optical assembly and an adjustment wheel and integrated slider, the adjustment wheel changing a diopter setting, and the slider moving the right optical assembly side to side to change an inter pupillary distance setting;
a left eye piece comprising a left optical assembly and a second adjustment wheel and a second integrated slider, the second adjustment wheel changing a diopter setting, and the second slider moving the optical assembly side to side to change an inter pupillary distance setting; and
an adjustable halo to support the optics module, the halo designed to be fixed around a user's head, wherein the halo is adjustable using a halo adjustment wheel positioned on a back of the headset.

19. The adjustable headset of claim 18, wherein the optics module is vertically moveable with respect to the halo such that the adjustable headset has an in-use mode and a social mode, where the optics module is positioned above the eyes of the user in the social mode, enabling the user to interact with others without removing the adjustable headset.

20. The adjustable headset of claim 19, wherein the optics module is horizontally moveable with respect to the halo using a sliding mechanism to slide the optics module forward and backward, to adjust a position of the optics module for eye relief adjustment while maintaining other settings.
